(19) United States
(12) Patent Application Publication
(10) Pub. No.: US 2011/0309588 A1
(43) Pub. Date: Dec. 22, 2011

(54) DEVICE FOR FASTENING A RING-SHAPED MILLING TOOL CARRIER

(75) Inventors: Markus Heinloth, Postbauer-Heng (DE); Walter Thurnwald, Stein (DE); Terry Takayama, Amberg (DE)

(73) Assignee: KENNAMETAL INC., Latrobe, PA (US)

(21) Appl. No.: 13/145,668

(22) PCT Filed: Nov. 24, 2009
(86) PCT No.: PCT/EP09/08340

§ 371 Date: Sep. 6, 2011

(30) Foreign Application Priority Data
Jan. 23, 2009 (DE) 10 2009 006 010.3

(51) Int. Cl. B23C 5/26; B23B 31/11

(52) U.S. Cl. 279/99

(57) ABSTRACT

A device for attaching a ring-shaped milling tool carrier (10) by means of a threaded connection to the machine receiver (11) is disclosed.

### BACKGROUND OF THE INVENTION

1. Field of the Invention

The invention relates to a device for fastening a ring-shaped milling tool carrier, in particular in the case of an internal milling cutter, to a machine receiver.

2. Description of Related Art

Ring-shaped milling cutter disks having inner cutters, preferably indexable inserts, have been known for a long time, also in respect of their use in crankshaft milling. The milling cutter disk described in DE 26 34 030 A1 consists of two circular-ring halves, which are detachably connected to one another and which, at two butt joints, each have a connecting link disposed in stepped recesses, at least one circular-ring half receiving in its recess a centering piece to which there is connected, via a screw, a cone piece that engages in an assigned conical recess of the connecting link.

DE 34 38 978 C1 describes a device for fastening a blade carrier of an internal milling cutter to the receiving flange of the milling cutter drum of a crankshaft milling machine by means of locking elements that, through the blade carrier of the internal milling cutter being pressed on against the receiving flange of the milling cutter drum, can be brought into bearing contact with mating surfaces on the respectively other part. Wedges, whose wedge surfaces are the mating surfaces, are fastened to the blade carrier or to the milling cutter drum. Disposed as locking elements on the milling cutter drum, or on the blade carrier, are wedges that act together therewith and are displaceable radially in respect of the blade carrier axis, an eccentric being in each case provided as a displacement drive for the displaceable wedge in such a manner that the combination of the eccentric with the wedge is self-locking.

Further, in DE 10 2007 013 153 A1 there is described a tool for external milling, which, on the outer periphery, has a plurality of cutting inserts, or cassettes fitted with cutting inserts, which are disposed on a ring-shaped or part-ring-shaped, segment-shaped, fastened carrier, which is detachably fixed either directly on a machine spindle or indirectly, via an adapter. Screws, clamping wedges or, also, bayonet connections serve as fastening means and also clamping means.

All aforementioned fastening possibilities are relatively complex, which renders tool making complicated and expensive, and renders handling of the milling cutters difficult during tool changing.

Although it is possible, in principle, to use directly sunk tools on ring-shaped internal milling cutters, which results in the advantage of easy construction, such that a tool change can be performed more easily by hand, disadvantageously, however, for production engineering reasons only few tools can be accommodated on the tool carrier in this case. The solution of using segment-shaped carriers does have the advantage that, in the event of an individual tool becoming unusable, e.g. in the event of an insert breakage, the segment concerned can be removed and replaced by another segment having a new cutting insert. Conflicting with the greater flexibility, on the other hand, is the disadvantage that the tool changing of all segments is relatively complex, since it is necessary to release provided clamping means for each segment, as well as tightening means, tightening screws, etc., in a large number in each case, and subsequently to apply them again during rechucking. This results in longer tool change times, which, as machine downtimes, increase the production costs.

Depending on the tool concept, key and slot connections that are necessary for torque transfer also result, particularly in the case of small tool widths, in a weakening of the tool carrier, with the increased risk of a tool breakage.

### SUMMARY OF THE INVENTION

There ensues therefrom the object of creating a fastening device, of the type mentioned at the outset, that is simple to produce and, for the purpose of achieving short tool change times, is easy to operate, and with which tool changing can be performed rapidly by hand.

This object is achieved by the device as claimed in claim 1.

According to the invention, a threaded connection is provided between a ring-shaped milling tool carrier, in particular an internal milling cutter ring, and the machine receiver.

A threaded connection can be manipulated easily and rapidly, since the releasing and screw tightening of additional fixing elements otherwise necessary in the prior art do not apply. Advantages also ensue in respect of production engineering, especially since few built-in components are required. Finally, owing to the realization of the carrier body as a ring, a saving in weight is achieved, whereby in tool changing a loading crane is rendered dispensable.

Further developments of the invention are given by the dependent claims.

Thus, in the case of an internal milling cutter, the ring-shaped milling tool carrier is provided with an external thread, and the machine receiver is provided with a correspondingly realized internal thread. Preferably, the external thread is made as a multiplex thread, such that “an easy pairing”, i.e. a facilitated assembly, is possible.

According to a further development of the invention, the milling tool carrier has a stop surface that determines the axial position in relation to the machine receiver when in the tightened state. In particular, this stop surface is realized as a ring-shaped end face, adjoining which, preferably, is a short-taper centering peg. The centering peg facilitates the introduction of the ring-shaped milling tool carrier onto or into the machine receiver. After the centering, the milling tool carrier is screwed in, an exact axial fixing of the position of the milling tool carrier in respect of the machine tool being achieved by the aforementioned end face stop. In addition, and in principle known from the prior art, the milling tool carrier can additionally be locked rotationally in relation to the machine receiver, for example by means of a screw or a clamping wedge. These accessories are fixed after the milling tool carrier has been screwed on.

In order to facilitate the handling of the milling cutter tool body, according to a further development of the invention the milling cutter tool body is provided, on the side facing away from the machine, with at least two drilled blind holes or tapped holes for receiving pins or screws of a bar-shaped gripping element. The gripping element preferably spans the ring-shaped milling tool body diagonally when in the mounted state, and can be used as a rotary accessory for screwing on and screwing off. Insofar as the connection between this rotary accessory and the ring-shaped milling tool carrier can be fixed, for instance by screws, the rotary accessory can also be used as a carrying aid for transport.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

Further realizations of the present invention are explained in the following with reference to the drawings, wherein:

FIGS. 1 and 2 show, respectively, a cross-sectional view and a plan view of a milling tool carrier in a machine receiver,

FIG. 3 shows a cross-sectional view of a milling tool carrier, and

FIG. 4 shows a plan view of this milling tool carrier, and

FIG. 5 shows an enlargement of the detail view B in FIG. 3.

### DETAILED DESCRIPTION OF THE INVENTION

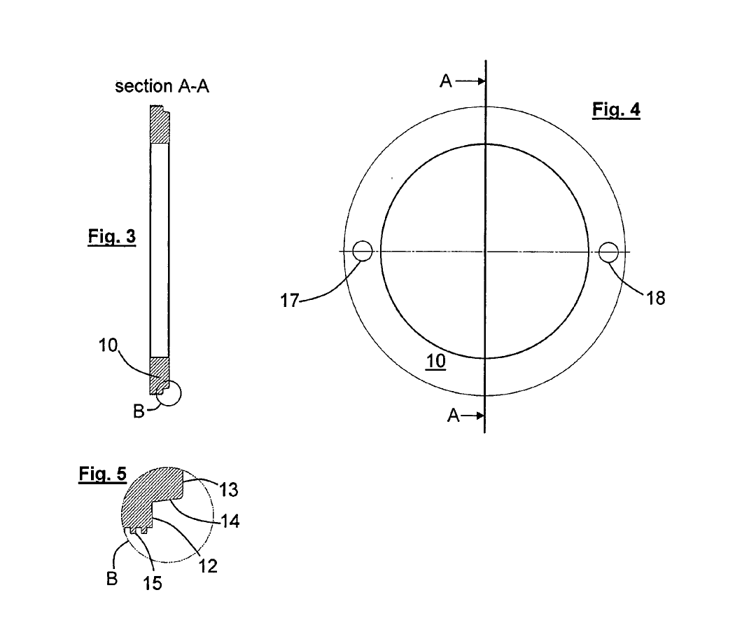

Ring-shaped milling tool carriers are known in principle from the prior art, such that, in the FIGS. 1 to 5 described in the following, only the essential differences from the prior art are considered.

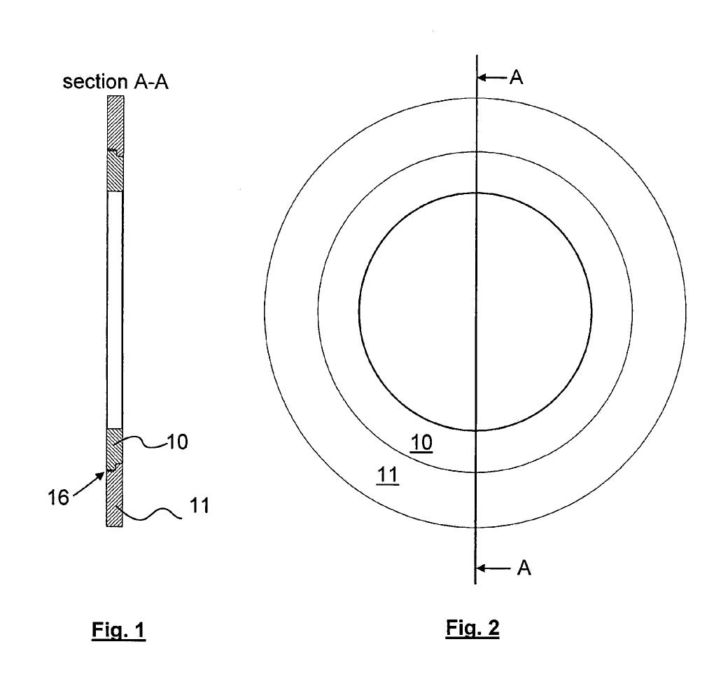

As can be seen from FIGS. 1 and 2, a milling tool carrier 10 is connected to the machine receiver 11 by means of a threaded connection 16. For clarity, cutting inserts disposed on the inner periphery of the milling tool carrier 10 have been omitted. These cutting inserts are usually fastened, by means of a tightening screw, in a respective insert seat, which can also be part of a cassette. Cutting inserts used are indexable inserts, which are exchanged following wear. In order to minimize the downtimes of the milling machine, in the case of wear of a milling tool the entire milling tool carrier is released, removed and exchanged for a replacement milling tool body, after which the milling machine can be used further. The tool changing, i.e. the changing of the cutting insert, on the removed milling cutter carrier body can be performed independently of the milling machine.

As can be seen, in particular, from FIG. 5, the milling tool carrier 10 has an end face stop surface 12 as a bearing contact collar, and further has a short-taper centering peg 13, whose circumferential surface 14 has a taper angle of 7° to 8°. The thread 15 is realized as an external thread.

Further locks against rotation or clamping wedges can be used, for which purpose reference is made to corresponding descriptions in DE 10 2007 013 153 A1, in particular FIGS. 6 to 8 and the associated description.

To make it easier to undo and screw on the milling tool carrier 10, diametrically opposing blind tapped holes can be provided, as indicated in FIG. 4, which serve as a fastening location for the ends of an elongate handle having corresponding holes, through which the screw is fastened and fixedly screwed in the tapped holes 17 and 18. This bow type handle serves as a rotary accessory and, because it is fastened to the milling tool carrier, can also serve as a carrying aid for transporting the milling tool carrier to the storage location or from the storage location to the machine tool. After the milling tool carrier has been mounted in the tool receiver, this accessory is removed before the milling cutter is put into operation.

The embodiment described above is suitable, in particular, for small type internal milling cutters, where the weight of the milling cutter carrier body is approximately 15 kg, such that handling “by hand”, without a loading crane or similar accessory, is possible. Basically, however, the design of a threaded connection according to the invention can also be used in the case of so-called external milling cutters, where the tools (cutting inserts) are disposed peripherally on the outside of the ring-shaped tool carrier. The thread in this case is provided as an internal thread on the inside of the ring, which thread corresponds with an external thread of a machine receiver.

1. A device for fastening a ring-shaped milling tool carrier to a machine receiver, comprising a threaded connection between the milling tool carrier and the machine receiver.

2. The device as claimed in claim 1, wherein the milling tool carrier has an external thread and the machine receiver has a correspondingly realized internal thread.

3. The device as claimed in claim 2, wherein the external thread of the milling tool carrier is realized as a multiplex thread.

4. The device as claimed in claim 1, wherein the milling tool carrier has a stop surface that determines the axial position in relation to the machine receiver when in the tightened state.

5. The device as claimed in claim 4, wherein the stop surface is realized as a ring-shaped end face, adjoining which is a short-taper centering peg.

6. The device as claimed in claim 1, wherein the milling tool carrier is locked rotationally in relation to the machine receiver by means of a screw or a clamping wedge.

7. The device as claimed in claim 1, wherein the milling tool body has at least two drilled blind holes or tapped holes, which are accessible from the side facing away from the machine, for receiving pins or screws of a bar-shaped gripping element, which spans the ring-shaped milling tool body diagonally when in the mounted state, and which can be used as a rotary accessory for screwing on and off.
